(19) United States
(12) Patent Application Publication
(10) Pub. No.: US 2010/0092708 A1
(43) Pub. Date: Apr. 15, 2010

(54) Method For Producing A Fibre Composite Component For Aerospace

(76) Inventors: Torben Jacob, Beckdorf (DE); Joachim Piepenbrock, Buxtehude (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/308,793

(22) PCT Filed: Jul. 5, 2007
(86) PCT No.: PCT/EP2007/056799

§ 371 Date: Nov. 5, 2009

Related U.S. Application Data
(60) Provisional application No. 60/818,930, filed on Jul. 6, 2006.

(30) Foreign Application Priority Data
Jul. 6, 2006 (DE) 10 2006 031 323.2

(51) Int. Cl. B29D 22/00; B29C 33/44; B29C 33/76

(52) U.S. Cl. 428/36.4; 264/219; 249/183

(57) ABSTRACT

Method for producing a fibre composite component, in particular for aerospace, having the following method steps: forming a moulding core from a core material with a predetermined narrow melting range in a moulding tool to establish an outer geometry of the moulding core at least partly laying at least one semifinished fibre product on the moulding core that is formed, for the shaping of at least one moulded portion of the fibre composite component to be produced; and multistage exposure of at least the moulded portion to heat and/or pressure to produce the fibre composite component; a corresponding moulding core for producing such a fibre composite component and a corresponding fibre composite component with at least one stringer.

The present invention relates to a method for producing a fibre composite component, in particular for aerospace, to a moulding core for producing such a fibre composite component and to a fibre composite component with at least one stringer which is produced by means of such a moulding core and/or such a method.

Although it can be applied to any desired fibre composite components, the present invention and the problems on which it is based are explained in more detail below with reference to two-dimensional stringer-stiffened carbon fibre reinforced plastic (CRP) components, for example skin shells of an aircraft.

It is generally known to stiffen CRP skin shells with CRP stringers in order to withstand the high loads in the aircraft sector with the lowest possible additional weight. In this respect, a distinction is made essentially between two types of stringers: T and Ω stringers.

The cross section of T stringers is made up of a base and a stem. The base forms the connecting surface with respect to the skin shell. The use of skin shells stiffened with T stringers is widespread in aircraft construction.

Ω stringers have something like a hat profile, its ends being connected to the skin shell. Ω stringers may either be adhesively attached in the cured state to the likewise cured shell, or be cured wet-in-wet at the same time as the shell. The latter is desired, because it is more favourable from technical aspects of the process. However, supporting or moulding cores are necessary for the wet-in-wet production of skin shells stiffened with Ω stringers, in order to fix and support the dimensionally unstable semifinished fibre products in the desired Ω shape during the production process. Skin shells with Ω stringers have the advantage over T stringers that they allow better infiltration during an infusion process for introducing a matrix, for example an epoxy resin, into the semifinished fibre products. Infusion processes can be inexpensive in comparison with other known methods for producing fibre composite components, such as the prepreg process for example, because this allows the use of lower-cost semifinished fibre products.

However, there is the problem with the production of stringers that the material used at present for the supporting or moulding core is cost-intensive and can only be removed with difficulty after the forming of the Ω stringers, with the result that the material remaining in the stringers contributes adversely to the overall weight of the aircraft.

Widely used, for example for the injection moulding of thermoplastics, is a fusible core technique, in which the production of a component is performed by injecting plastic around a lost moulding core of a low-melting alloy, which is formed from a eutectic alloy of certain metals. After the plastic has been injected, the lost moulding core is melted out by induction heating or in a heated bath, after which the finished component is washed. However, this technique may have the disadvantage that, because of its toxicity, the eutectic low-melting alloy requires laborious treatment and safety measures.

Against this background, the present invention is based on the object of providing a lower-cost and lighter fibre composite component, in particular for aerospace.

According to the invention, this object is achieved by a method with the features of Patent claim 1, a moulding core with the features of Patent claim 19 and/or by a fibre composite component with the features of Patent claim 29.

Accordingly, a method for producing a fibre composite component, in particular for aerospace, is provided, comprising the following method steps:

forming a moulding core from a core material with a predetermined narrow melting range in a moulding tool to establish an outer geometry of the moulding core; at least partly laying at least one semifinished fibre product on the moulding core that is formed, for the shaping of at least one moulded portion of the fibre composite component to be produced; and multistage exposure to heat and/or pressure to produce the fibre composite component.

Also provided is a moulding core for producing a fibre composite component, in particular a stringer on a base part, comprising a core material of plastic that has a defined narrow melting range.

Also provided is a fibre composite component with at least one stringer, in particular for aerospace, which is produced by means of the moulding core according to the invention and/or the method according to the invention.

Consequently, the present invention has the advantage over the approaches mentioned at the beginning that the fibre composite component can be produced by means of a lower-cost moulding core. Instead of an expensive conventional core material, a lower-cost plastic can be advantageously used. A further advantage that is obtained is that this plastic is reusable.

Advantageous refinements and improvements of the present invention can be found in the subclaims.

According to a further preferred development of the invention, the core material of the moulding core is formed with a core sleeve enclosing it. In a particularly preferred embodiment of this it is provided that the core sleeve is formed as a flexible tube that can be closed at both ends. The tube is in this case formed in such a way that it has at least two portions, each of which has at least the internal volume of the at least one moulded portion of the fibre composite component to be produced. In a first of the at least two portions of the flexible tube, the core material to be melted can consequently be arranged. The second of the at least two portions is introduced into the moulding tool for shaping, the molten core material being brought into the first portion, arranged in the moulding tool, by means of the force of its weight and/or some other force applied to it. This advantageously permits recycling of the core material, which can always remain in the flexible tube for the creation of the core and the later melting out and can be reused.

According to a further preferred exemplary embodiment of the invention, reinforcing means are arranged in the region of transitions, to be formed with sharp edges, of the outer geometry of the moulding core to be formed, inside and/or outside the core sleeve. These reinforcing means, in particular corner profile parts, have the advantage that they form the sharp edges and corners, it being possible for the moulding core to be provided in this region with easy-to-produce rounded portions.

A release layer, which reduces adhesive attachment of the semifinished fibre product and/or a matrix to the core sleeve, is preferably applied to the core sleeve. This facilitates removal of the core sleeve after the at least partial curing of the portion of the fibre composite component that is created by means of the moulding core.

Semifinished fibre products are to be understood as meaning woven or laid fabrics and fibre mats. These are provided with a matrix, for example an epoxy resin, and subsequently cured, for example in an autoclave.

According to a further preferred development of the invention, the moulding core is arranged on a base part comprising semifinished fibre composite products and/or is at least partially surrounded by semifinished fibre products to form at least one moulded portion of the fibre composite component. Consequently, base parts, for example skin shells, pressure domes, etc. with Ω stringers can be advantageously formed. As an alternative or in addition, separate fibre composite components, which are defined entirely in their form by the moulding core, can also be produced.

It is preferred that, in the multistage exposure to heat and/or pressure, a pre-curing stage is provided. This pre-curing serves for partially solidifying the fibre composite component below the melting temperature of the core material; to be precise to the extent that the fibre composite component would be adequately dimensionally stable even without the moulding core. This makes it possible for the moulding core to be removed from the mould even before the fibre composite component has completely cured right through. The pre-curing is performed to retain the at least one moulded portion of the fibre composite component to be produced without the moulding core by applying heat at a temperature below the melting temperature of the core material in a time period that can be fixed. As a result, it is advantageously possible to use a core material with a predetermined narrow melting range. The moulded portion is pre-cured in a certain time at a temperature below the melting point of the core material to the extent that it remains dimensionally stable without the moulding core. Consequently, complete removal of the moulding core is advantageously possible after this pre-curing.

After that, melting out of the core material to remove the same is performed in a melting-out stage by exposure to heat at a second temperature, above the melting temperature of the core material. For this purpose, the operation of removing the core material can again be advantageously made possible by the force of its weight or some other force applied to the moulding core. The core sleeve or the flexible tube is then removed from the moulded portion, so that the complete moulding core is advantageously removed from the moulded portion. After that, curing of the pre-cured fibre composite component without the moulding core takes place in a curing stage. The temperature of the curing stage advantageously corresponds to that of the melting-out stage, so that the residual curing can take place in parallel, following on after the melting out, within one temperature step.

After the melting out, the core material can be put to further use. In the case of a core sleeve, the molten core material is suitably collected and can likewise be reused.

For example in the case of the production of a Ω stringer, the core sleeve is drawn out from it in the longitudinal direction of the stringer. Consequently, the core then no longer contributes to the overall weight of the aircraft.

According to a preferred development of the invention, the moulding core is formed with at least one undercut. This undercut preferably lies in the longitudinal direction of the moulding core. Consequently, stringers of variable cross section in their longitudinal direction can be produced by means of such a moulding core. It is also advantageous that the core sleeve or the flexible tube can be removed from the moulding core with an undercut.

The invention is explained in more detail below on the basis of the exemplary embodiments represented in the schematic figures of the drawing, in which:

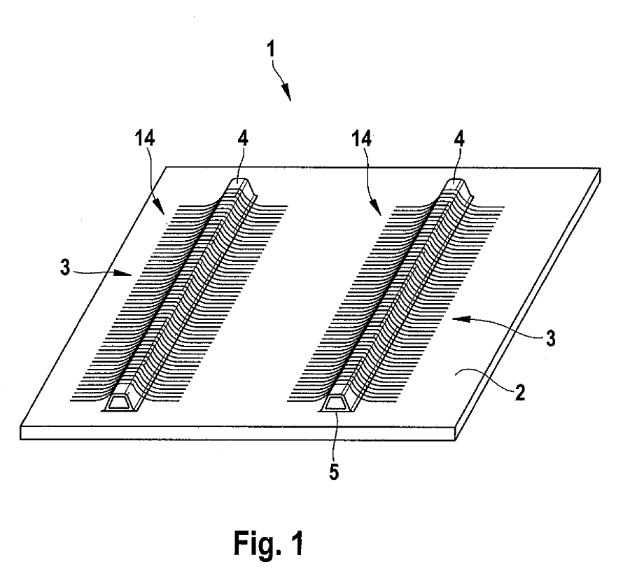

FIG. 1 shows a schematic perspective view of a first exemplary embodiment of a fibre composite component during production as provided by a method according to the invention;

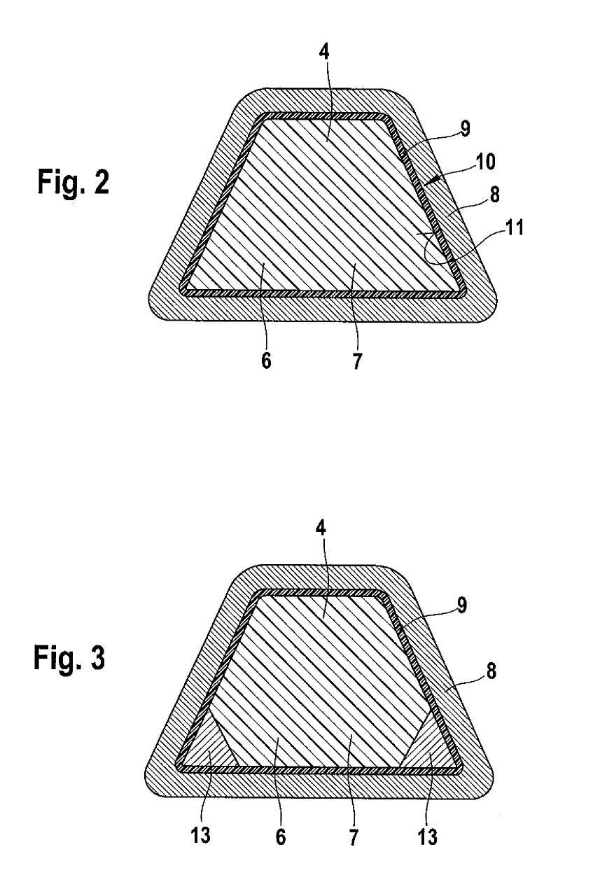

FIG. 2 shows a schematic sectional representation of a first moulding core according to the invention of the fibre composite component as shown in FIG. 1;

FIG. 3 shows a schematic sectional representation of a second moulding core according to the invention of the fibre composite component as shown in FIG. 1;

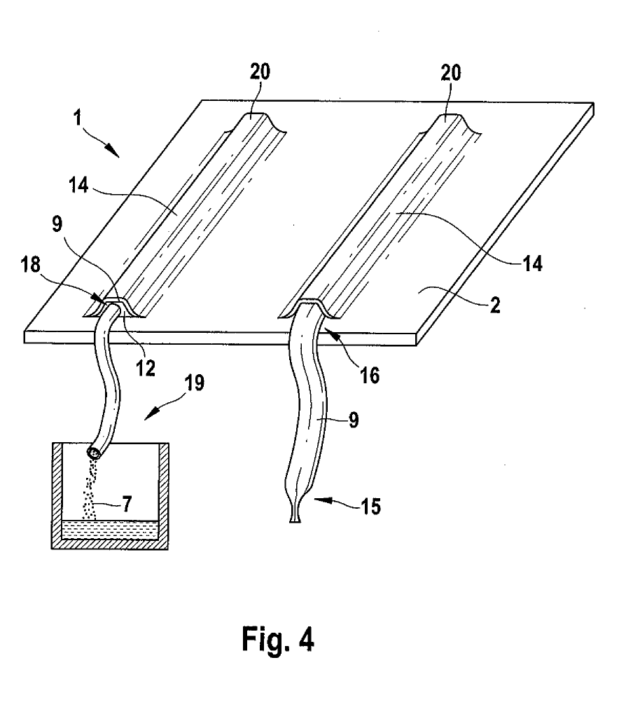

FIG. 4 shows a schematic perspective view of the fibre composite component as shown in FIG. 1 during the removal of two different moulding cores as provided by the method according to the invention;

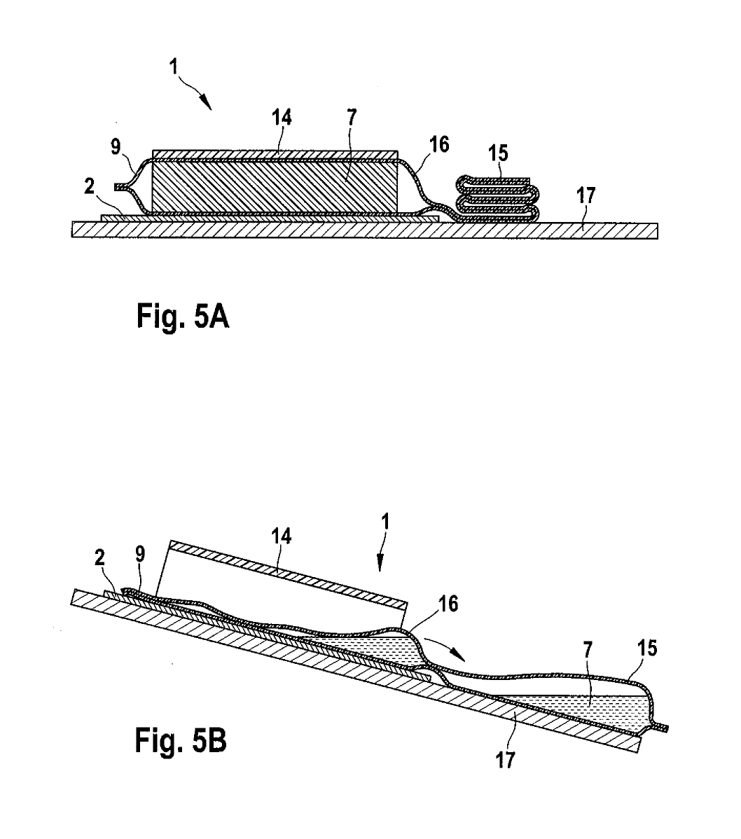

FIG. 5A shows a schematic side view of the fibre composite component comprising a moulding core with a flexible tube as provided by the method according to the invention;

FIG. 5B shows a schematic side view of the fibre composite component as shown in FIG. 5A during the removal of the moulding core with the flexible tube as provided by the method according to the invention; and

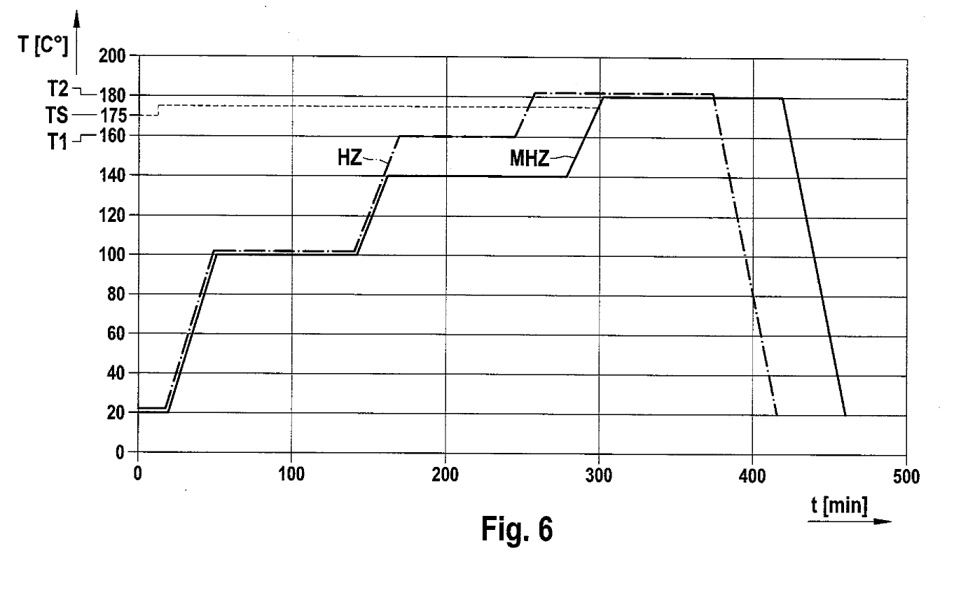

FIG. 6 shows a diagram of curing cycles of a fibre composite component as provided by the method according to the invention in comparison with a conventional curing cycle.

In all the figures of the drawings, elements that are the same or functionally the same have in each case been provided with the same reference numerals, unless otherwise indicated.

FIG. 1 shows a schematic perspective view of a first exemplary embodiment of a fibre composite component 1 during production as provided by a method according to the invention.

This example has two moulding cores 4, the number not being restricted to two. The two moulding cores 4, the production of which is explained further below, are provided with an approximately trapezoidal cross section with their base 5 resting on a base component 2.

In a further step, semifinished fibre products 3 are laid on the moulding cores 4. The semifinished fibre products 3 thereby lie with a middle portion on the outer surface of the moulding cores 4 and with their ends on the base component 2, for example on the skin of an aircraft. As a result, two moulded portions 14 of the fibre composite component 1 are formed.

Various production methods may be used for producing the fibre composite component. What is known as the vacuum infusion process is preferably chosen here. However, the prepreg process can similarly be used here.

In a further step, the base component 2 is cured with the moulding cores 4 and the semifinished fibre product 3 in an autoclave under the effect of heat and pressure according to a curing cycle, which is described in detail further below, whereby the complete fibre composite component 1 is produced.

First, the creation of the moulding cores 4 is described on the basis of FIGS. 2 and 3.

FIG. 2 shows a schematic sectional representation of a first moulding core 4 according to the invention of the fibre composite component 1 as shown in FIG. 1 in a cross section.

The moulding core 4 includes a core material 7, which is introduced into a moulding tool 8 and in this tool is brought into the desired shape with a cross section 6 of the moulding core 4, here an approximately trapezoidal form. Preferably, the core material is melted and cast into the desired shape. In this example, the core material 7 is surrounded by a core sleeve 9, which completely encloses the moulding core 4 and is suitable for the method that is used for its production and its further working and processing, with regard to the process temperature and the process pressure. The core sleeve 9 comprises, for example, a polyamide or a PTFE plastic. It lies with its inner side 11 directly on the surfaces of the moulding core 4, in this example its outer side 10 being coated with a release layer (not shown), which may also comprise an additional sleeve. The release layer serves for the correct release of the moulding core 4 from the moulded portion 14 when it is removed from the mould.

In a preferred embodiment, the core material 7 is a plastic with a defined narrow melting range, such as for example a polyamide PA12, PA11 or polypropylene PP GF30. Further plastics with a narrow melting range are ECTFE, PVDF, THV or POM-H. The melting range is discussed in detail with reference to FIG. 5.

FIG. 3 shows the moulding tool 8 with a moulding core 4 of a different cross section 6, in which the lower corner regions are replaced by reinforcing means 13, for example strips of metal or plastic. In this way, the moulding core 4 can be provided with particularly well-formed corner regions, by the reinforcing means 13 being fabricated in a separate tool.

The moulding cores 4 created in this way are removed from the moulding tool 8 and applied to the base component 2 in the way described above.

The fibre composite component 1 produced by the specific curing cycle explained further below with reference to FIG. 6 is represented in FIG. 4 in a perspective view during the removal of the moulding cores 4 from the mould.

After a pre-curing, which is performed at a temperature (see FIG. 6) that lies below the melting temperature TS of the core material 7, for example a first temperature T1, the moulding cores 4, which include the core material 7 with a narrow melting range, are melted out at a second temperature T2, above the melting temperature TS, from the moulded portions 14 formed by them. These moulded portions 14 are in this example two Ω-shaped stringers 20 for stiffening the base component 2.

On the left-hand side of FIG. 4, a collecting device 19 is connected at the end of the core sleeve 9 lying at the front, by means of a connection device 18 not represented any more specifically. For this purpose, the core sleeve 9 has previously been opened. It may, however, also already contain such a connection device 18. The other end of the core sleeve 9, on the opposite side, is closed, since it completely encloses the moulding core 4 in the way described above.

The collecting device 19 comprises, for example, a heated line and a collecting vessel for the molten core material 7. To remove the molten core material 7 from the moulded portion 14, the base component 2 can be pivoted, in order that the molten core material 7 flows out under its gravitational force. At the same time or instead of this, a pressure which brings about and/or assists the flowing out of the molten core material 7 may be applied to the moulding core 4 from the end of the moulded portion 14 lying opposite the collecting device 19.

Once the core material 7 has flowed out completely, the core sleeve 9 is drawn out from the moulded portion 14. It may also be brought out already by the pressure applied. The release layer applied to the core sleeve 9 or a moulding core 4 without a core sleeve 9 is advantageous for this process. The core sleeve 9 can consequently be drawn out from the moulded portion 14 in the longitudinal direction without any problem. This is also possible if the moulded portion 14 or the stringer 20 has undercuts in the longitudinal direction. Such removal of the core sleeve 9 or the moulding core 4 from the mould is therefore made possible. The fibre composite component 1 can then be further processed.

If reinforcing means 13 are used, they may be melted out at the same time or remain in the component, depending on the embodiment.

In a further configuration, the core sleeve 9 is formed as a flexible tube that can be closed at both its ends, as schematically shown on the right-hand side of FIG. 4. A collecting device 19 is in this case not necessary, since the core sleeve 9 is formed as a flexible tube with two portions 15, 16, of which a first portion 15 is arranged outside the moulded portion 14 and a second portion 16 forms the moulding core 4 inside the moulded portion 14 with core material 7 that has been introduced and shaped in this second portion 16.

Both portions 15 and 16 of the flexible tube are designed in such a way that they respectively have at least the entire internal volume of the moulded portion 14. For this purpose, FIG. 5A shows an arrangement of the fibre composite component 1 with the base component 2 and the moulded portion 14, which is formed by the second portion 16 of the flexible tube or the core sleeve 9 formed as a flexible tube. The flexible tube is closed at the left-hand end and protrudes by a certain amount out of the right-hand end of the moulded portion 14. The entire arrangement is located on a base plate 17, which serves as a working plate. The base plate 17 is extended beyond the right-hand end of the base component 2, forming a place for the first portion 15 of the flexible tube, which is folded up here.

After the pre-curing of the fibre composite component 1 specified above, the moulding core 4 is removed with the flexible tube, by the second temperature T2 melting the core material 7 in the second portion 16 of the flexible tube inside the moulded portion 14, as is shown in FIG. 5B. As this happens, the base plate 17 is tilted in such a way that the molten core material 7 flows out from the second portion 16 of the flexible tube into its first portion 15 under the effect of gravitational force and/or a force applied to the other end of the flexible tube. After that, the flexible tube is drawn out from the moulded portion 14, a release layer on the tube, for example in the form of an additional sleeve, in turn assisting the operation of removing it from the mould.

After removal from the mould, this tube core is reused, in that the second portion 16 is introduced into a corresponding moulding tool 8, which can easily be imagined here for example in place of the moulded portion 14. An associated base plate 17 is tilted oppositely to the representation in FIG. 5B, the first portion 15 of the flexible tube being heated to melt the core material 7 located in it, and this material flowing into the moulding tool 8. The core material 7 is closed in an airtight manner in the flexible tube, and consequently can be advantageously worked and processed without being under the effect of air and without any effect on the air. When such a moulding core 4 with a flexible tube is being created for the first time, the first or second portion of the flexible tube is filled with core material 7 and then correspondingly closed.

The curing cycle for producing the fibre composite component 1 comprises a number of stages, which are now explained with reference to FIG. 6 by the example of a conventional curing cycle of a vacuum infusion process. In the case of a prepreg process, there is no infiltration stage for example.

Plotted on the x axis is the time in minutes and on the y axis the temperature T in ° C.

The dash-dotted curve, denoted by HZ, represents a conventional multistage curing cycle HZ for a specific resin, in the case of which the temperature for curing the fibre composite component 1 is increased in stages, for example in an autoclave, with dwell times at certain temperatures.

The solid curve, denoted by MHZ, shows a modified curing cycle for the method according to the invention.

At a temperature of approximately 100° C., what is known as infiltration, that is to say the introduction of a matrix into the semifinished fibre product, takes place in the curing cycle; until then, the shape of the two curves HZ and MHZ is identical. The conventional curing cycle HZ subsequently proceeds at a higher temperature of approximately 160° C., and is finally increased to a stage at approximately 180° C. for the final curing.

The modified curing cycle MHZ is kept at a first temperature T1, known as the pre-curing stage, which in this example corresponds to approximately 140° C., for a specific period of time that can be fixed in advance. This period of time is primarily dependent on the matrix material used, for example the epoxy resin, and is maintained until the moulded portion 14 would remain adequately dimensionally stable even without the moulding core 4. This time can be determined experimentally with the respective materials.

After the pre-curing, the moulded portion 14 is dimensionally stable to the extent that the vacuum packing for the vacuum infusion process can be removed. Then the temperature is raised to the final temperature, namely a second temperature T2, which is approximately 180° C. here. This second temperature T2 is higher than the melting temperature TS of the core material 7, in this example a plastic PA12 with a melting point/range of about 175° C., the core material 7 melting and being in a state in which it can be removed. The fibre composite component 1 thereby undergoes further, final curing. Depending on the materials used, the overall time of the modified curing cycle MHZ may be longer here than the time of the conventional curing cycle HZ.

The core material 7 preferably comprises a plastic, for example polyamide PA12. This polyamide has a maximum brief working temperature of 150° C.; the melting point is at 175° C. With the addition of fillers, for example glass fibre shreds, this melting range can be further reduced. In the case of a polypropylene with a 30% glass fibre content, for example PP GF30, the temperatures are only approximately 10° C. apart. The viscosity of the molten core material 7 falls as the temperature increases. Therefore, the melting-out operation is made easier when it is increased in the direction of the injection-moulding temperature of the respective material.

Consequently, a method for producing a fibre composite component, a corresponding moulding core and a corresponding fibre composite component that can achieve a significant reduction in material costs in comparison with the prior art with conventional materials are provided. The moulding core is completely removed, whereby the weight of the fibre composite component can be reduced in comparison with the prior art with conventional core materials that remain in it.

The invention is not restricted to the specific method represented in the figures for producing a fibre composite component for aerospace.

For example, the idea of the present invention can also be applied to fibre composite components in the sports equipment or motor sports sector.

Furthermore, the geometry of the moulding core can be modified in various ways.

Furthermore, it is also possible for a number of moulding cores to be used to form one moulding core, around which semifinished fibre products are placed. The aim of this is to create a more complex geometry by means of the multiplicity of moulding cores. Consequently, more complex fibre composite components can be produced.

The reinforcing means 13 may be arranged inside the core sleeve 9 or else outside the core sleeve 9.

The temperature during the melting out of the core material 7 may at the same time be the curing temperature of the fibre composite component 1.

### LIST OF DESIGNATIONS

1 fibre composite component
2 base component
3 semifinished fibre product
4 moulding core
5 base of the moulding core
6 cross section of the moulding core
7 core material
8 moulding tool
9 core sleeve
10 outer side of the core sleeve
11 inner side of the core sleeve
12 opening of the core sleeve
13 reinforcing means
14 moulded portion
15 first tube portion
16 second tube portion
17 base plate
18 connection device
19 collecting device
20 stringer
HZ curing cycle
MHZ modified curing cycle)
T temperature
T1, T2 temperatures
TS melting temperature

What is claimed is:

1. A method for producing a fibre composite component, in particular for aerospace, the method comprising:
forming a moulding core from a core material with a predetermined narrow melting range in a moulding tool to establish an outer geometry of the moulding core, the core material of the moulding core being provided with a core sleeve enclosing it, the sleeve being a flexible tube that can be closed at both ends, the tube being provided with at least two tube portions, each of which has at least the internal volume of at least one moulded portion of the fibre composite component to be produced, and one of the two tube portions being provided for receiving the moulding core and the other of the two tube portions being provided as a reservoir for receiving molten core material of the moulding core;
at least partly laying at least one semifinished fibre product on the moulding core that is formed, for the shaping of the at least one moulded portion of the fibre composite component to be produced; and
multistage exposure of at least the moulded portion to heat and/or pressure to produce the fibre composite component, wherein a melting-out of the core material and a curing of the fibre composite component take place in parallel within one temperature step.

2. The method according to claim 1, wherein, when forming the moulding core, the core material to be melted is arranged in a first portion of the at least two portions of the flexible tube and the second portion of the at least two portions is introduced into the moulding tool, the molten core material being brought into the first portion, arranged in the moulding tool, by means of a force applied to it.

3. The method according to claim 1, wherein, when forming the moulding core, reinforcing means are arranged in the region of transitions, to be formed with a sharp edge, of the outer geometry of the moulding core to be formed.

4. The method according to claim 1, wherein, after the forming of the moulding core, a release layer, which reduces adhesive attachment of the semifinished fibre product and/or a matrix to the core sleeve, is applied to the core sleeve.

5. The method according to claim 4, wherein the release layer is applied in the form of a sleeve.

6. The method according to claim 1, wherein, during the at least partial laying of at least one semifinished fibre product, the moulding core is arranged on a base component comprising semifinished fibre composite products and/or is at least partially surrounded by semifinished fibre products to form the at least one moulded portion of the fibre composite component.

7. The method according to claim 1, wherein, in the multistage exposure to heat, pre-curing is performed in a pre-curing stage to obtain partial solidification to create adequate dimensional stability even without a moulding core of the least one moulded portion of the fibre composite component to be produced, by applying heat at a first temperature (T1), below the melting temperature (TS) of the core material, in a time period that can be fixed; wherein subsequently melting-out of the core material is performed in a melting-out stage to remove the said material by applying heat at a second temperature (T2), above the melting temperature (TS) of the core material; and subsequently curing of the pre-cured fibre composite component without the moulding core is performed in a curing stage.

8. The method according to claim 7, wherein, when melting out the core material, at least one collecting device for leading away the molten core material via a heatable line into a container is arranged such that it is connected at least one end of the at least one moulded portion to the latter or to the core sleeve, the molten core material being removed by the force of its weight in a suitable position of the moulded portion or by at least one force applied to the moulding core.

9. The method according to claim 8, wherein, when melting out the core material, a melt head with a suction extractor is pushed into the end of the at least one moulded portion, provided with the moulding core, for local melting and extraction by suction of the core material.

10. The method according to claim 7, wherein, when melting out the core material, the molten core material is brought into the tube portion of the two tube portions that is intended as a reservoir by the force of its weight in a suitable position of the moulded portion or by at least one force applied to the moulding core.

11. The method according to claim 7, wherein, after the melting out of the core material, the core sleeve is removed from the at least partially cured moulded portion of the fibre composite component.

12. The method according to claim 1, wherein the moulding core is formed with at least one undercut.

13. The method according to claim 1, wherein a plastic, such as a polyamide or polypropylene, is used as the core material.

14. A moulding core for producing a fibre composite component, such as a stringer on a base component in aerospace, comprising a core material with a predetermined narrow melting range, the moulding core having a core sleeve, and the core sleeve being a flexible tube, which has at least two tube portions, each of which has at least the internal volume of at least one moulded portion of the fibre composite component to be produced, and the moulding core being arranged in the second tube portion of the at least two tube portions and the first tube portion of the at least two tube portions being intended as a reservoir for molten core material.

15. The moulding core according to claim 14, wherein the core sleeve is provided with a release layer, which forms an outer surface of the moulding core.

16. The moulding core according to claim 15, wherein the release layer is applied in the form of a sleeve.

17. The moulding core according to claim 14, wherein the core sleeve comprises a material that is suitable for the process temperature and the process pressure, such as a polyamide and/or a PTFE plastic.

18. The moulding core according to claim 14, wherein the moulding core has at least one undercut.

19. The moulding core according to claim 14, wherein reinforcing means are arranged in the moulding core in the region of transitions, to be formed with sharp edges, of its outer geometry.

20. The moulding core according to claim 14, wherein the moulding core is formed such that it is Ω-shaped, trapezoidal, triangular, annular and/or wavy.

21. The moulding core according to claim 14, wherein the core material is a plastic, such as a polyamide or polypropylene.

22. A fibre composite component with at least one stringer, in particular for aerospace, which is produced by a method according to claim 1.

23. A fibre composite component with at least one stringer, in particular for aerospace, which is produced by means of a moulding core according to claim 14.

24-26. (canceled)
